(19) United States
(12) Patent Application Publication
(10) Pub. No.: US 2026/0176908 A1
(43) Pub. Date: Jun. 25, 2026

(54) OBJECT MOVING DEVICE

(71) Applicant: HI-LEX CORPORATION, Hyogo (JP)

(72) Inventors: Taichi MORI, Hyogo (JP); Takayuki IMAOKA, Hyogo (JP)

(21) Appl. No.: 19/128,248

(22) PCT Filed: Nov. 21, 2023
(86) PCT No.: PCT/JP2023/041848

§ 371 Date: May 8, 2025

(30) Foreign Application Priority Data
Nov. 25, 2022 (JP) 2022-187901

(51) Int. Cl. B60N 2/07; A61H 3/04; B60N 2/54; B63B 34/56; E05F 11/38; E05F 11/48

(52) U.S. Cl. CPC E05F 11/486; E05F 11/382; E05F 11/385; E05F 11/483; E05F 11/485

(57) ABSTRACT

An object moving device comprises a drive device, an inner cable that is wound and unwound by the drive device, a moving member that is raised and lowered together with a moving object by winding and unwinding of the inner cable, a guide rail extending in a moving direction of the moving object, wherein the guide rail slidably engages with the moving member and is capable of guiding a movement of the moving member, a cushioning member provided on the moving member, and a receiving portion that is provided on a member mounted to the guide rail and abuts onto the cushioning member to restrict the movement of the moving member. The receiving portion is a structure having a high frictional force portion provided at a site where the receiving portion abuts onto the cushioning member.

### TECHNICAL FIELD

The present invention relates to an object moving device that raises and lowers a moving member to which a moving object is mounted.

### BACKGROUND ART

Conventionally, as an object moving device that raises and lowers a moving member, for example, a window regulator that raises and lowers a window glass of a vehicle has been known.

For example, Patent Document 1 discloses a window regulator comprising a guide rail that guides a carrier plate to be freely raised and lowered, which is a moving member that holds a window glass, and a drive mechanism that reciprocates a cable coupled to the carrier plate. A cushioning member is provided at the lower end of the above-described carrier plate, and in a housing of the drive mechanism, a receiving portion is provided which abuts onto the above-described cushioning member when the carrier plate is lowered, thereby restricting lowering of the carrier plate.

### PRIOR ART DOCUMENT

### Patent Document

Patent Document 1: WO2012/002093

In an automobile window regulator, since a guide rail is curved to be convex toward an outside of a vehicle, a cushioning member of the carrier plate receives a rotational moment in a direction away from the guide rail when a carrier plate sliding on the guide rail is pulled down by a cable and reaches a lower end position, whereby the cushioning member of the carrier plate abuts onto a receiving portion. Therefore, when a force in a lower end direction was further applied to the carrier plate even after the cushioning member abuts onto the receiving portion, or when the cushioning member repeatedly abuts the receiving portion, there was a risk that the cushioning member would fall off from the carrier plate due to the above-described rotational moment.

It is an object of the present invention to provide an object moving device that can suppress a cushioning member from falling off from a moving member due to abutment of the cushioning member onto a receiving portion.

### SUMMARY OF THE INVENTION

### Means to Solve the Problem

The object moving device according to one aspect of the present invention comprises a drive section, a cable that is wound and unwound by the drive section, a moving member to which a moving object is mounted, wherein the moving member is raised and lowered together with the moving object by winding and unwinding of the cable, a guide rail extending in a moving direction of the moving object, wherein the guide rail slidably engages with the moving member and is capable of guiding a movement of the moving member, a cushioning member provided on the moving member, and a receiving portion that is mounted to the guide rail and abuts onto the cushioning member to restrict the lowering of the moving member, wherein the receiving portion has a processed part for increasing a frictional force between the receiving portion and the cushioning member, wherein the processed part is provided at least at a site where the receiving portion abuts onto the cushioning member.

### Effects of the Invention

According to the present invention, an object moving device can be provided which can suppress a cushioning member from falling off from a moving member due to abutment of the cushioning member onto a receiving portion.

### BRIEF DESCRIPTION OF THE DRAWINGS

FIG. 1 is an example of a perspective view of a typical object moving device.

FIG. 2 is an example of a perspective view of a moving member when viewed from below on the front side.

FIG. 3 is an example of a perspective view of a periphery of the moving member when viewed from above on the front side.

FIG. 4 is an example of a schematic view showing side surfaces of a cushioning member and a stopper when viewed from the left side, in which (A) is a view showing a state when the cushioning member abuts onto the stopper, (B) is a view showing a state when the cushioning member comes off from a fitting portion, and (C) is a view showing a state after the cushioning member comes off from the fitting portion.

FIG. 5 is an example of a perspective view of a periphery of a moving member provided in the object moving device according to the present embodiment, when viewed from above on the front side.

FIG. 6 is an example of a perspective view of a periphery of a moving member provided in an object moving device according to a variation, when viewed from above on the front side.

### EMBODIMENT FOR CARRYING OUT THE INVENTION

An embodiment that is an example of the present invention will be described below with reference to the drawings. The object moving device according to the present embodiment is mounted to, for example, a door of a vehicle and is used as a window regulator or the like for raising and lowering a moving object (e.g., a window glass of the vehicle).

### Summary of Object Moving Device

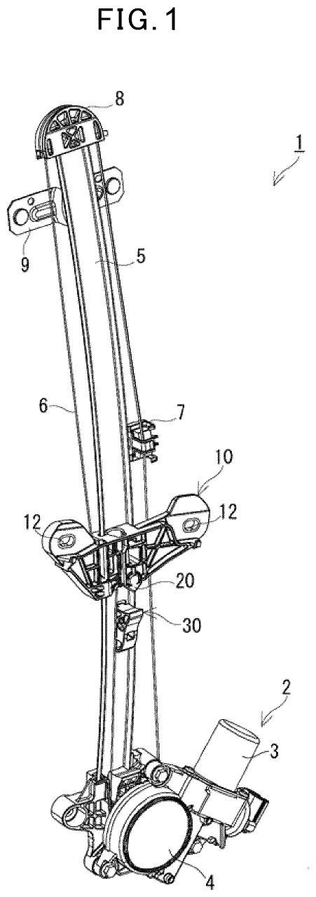

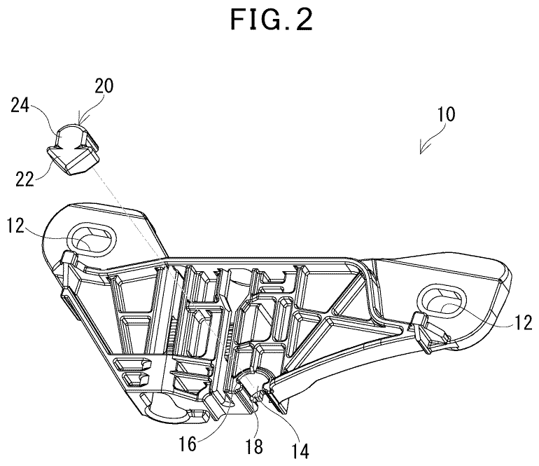

FIG. 1 is an example of a perspective view of a typical object moving device 1. In this specification, directions are defined as being viewed from above on the front side of the object moving device 1 shown in FIG. 1. Moreover, a left direction when viewed from the front side is defined as a left side, and a right direction when viewed from the front side is defined as a right side. The same definitions of directions are applied to FIG. 2 to FIG. 6 mentioned below.

As shown in FIG. 1, the object moving device 1 mainly comprises a drive device 2, a moving member 10 capable of moving in an upward and downward direction, a guide rail 5 composed of a substantially rectangular plate-shaped member having a predetermined length in the upward and downward direction, an inner cable 6 that moves the moving member 10 in the upward and downward direction by the drive device 2, a cable guide 7 that restricts a routing path of the inner cable 6 to follow the guide rail 5, a direction changing member 8 provided at the upper end of the guide rail 5, a bracket 9, and a stopper 30.

The drive device 2 is mounted to the lower end of the guide rail 5 and is arranged to be located below a lower limit position of the moving member 10. This drive device 2 has, for example, a drum (not shown) that winds up and sends out the inner cable 6, a motor 3 that drives this drum, and a housing 4 for accommodating a reducer (not shown) such as a worm gear reducer that is coupled to the motor 3. In the object moving device 1 shown in FIG. 1, the drive device 2 is mounted to the lower end of the guide rail 5, but it should be noted that a position of the drive device is not limited to this. The drive device may be provided at a central portion of the guide rail or at another location and may be configured as a separate body from the guide rail. The above-described “drive device 2” corresponds to the “driving section” of the present invention.

The moving member 10 is arranged to face one surface of the guide rail 5 and is slidably engaged along the guide rail 5 extending in the upward and downward direction. A movement of the moving member 10 in the upward and downward direction is guided by the guide rail 5. Although not shown in detail, the moving member 10 is provided with a cable end-connecting portion for mounting an end of the inner cable 6. Moreover, in the moving member 10, two fixing holes 12 for fixing, for example, a window glass (not shown) of a vehicle with a screw or the like are formed. This moving member 10 is integrally molded with, for example, a synthetic resin or the like, but a material is not particularly limited to the synthetic resin. The material of the moving member 10 may be metal, a combination of metal and a synthetic resin, or the like.

The guide rail 5 is a metal thin plate such as a galvanized steel plate, which is formed to be curved like an arch in the upward and downward direction. For example, a window glass fixed to the fixing hole 12 of the moving member 10 is raised and lowered in the upward and downward direction with a curved trajectory. Moreover, a cable guide 7 is mounted to the guide rail 5.

The inner cable 6 is configured to move the moving member 10 upward and downward by the drive device 2, where one end of the inner cable 6 is wound around a drum (not shown) and the other end is coupled to the moving member 10. With the inner cable 6 being not restricted by the cable guide 7, the inner cable 6 is linearly routed to follow the shortest distance between the direction changing member 8 provided at the upper end of the guide rail 5 and the above-mentioned drum (not shown) provided at the lower end of the guide rail 5. The above-described “inner cable 6” corresponds to the “cable” of the present invention.

The cable guide 7 is mounted to the guide rail 5 as mentioned above, and has a function of suppressing abnormal noise caused by vibration of the inner cable 6. At least a part of the cable guide 7 is always in contact with the inner cable 6, and the cable guide 7 is configured so that the inner cable 6 slides when the moving member 10 moves in the upward and downward direction.

The direction changing member 8 functions as a member for changing a moving direction of the inner cable 6. This direction changing member is not particularly limited as long as it is a member capable of changing a routing direction by winding the inner cable around it, such as a pulley and a cable guide.

The bracket 9 is a member for mounting the object moving device 1 to another member (e.g., a door of a vehicle).

The stopper 30 is configured to restrict a downward movement of the moving member 10 so as to stop the moving member 10 at the lower limit position. The stopper 30 is a member that abuts onto a cushioning member 20 mentioned below at the lower limit position where movement of the moving member 10 is desired to be stopped when the moving member 10 moves downward, and is provided on the guide rail 5 below the moving member 10.

Both the cushioning member 20 and the stopper 30 can be composed of, for example, POM (polyacetal) that is excellent in abrasion resistance to be used as a material.

### Details of Cushioning Member and Stopper

Next, the cushioning member 20 and the stopper 30 will be described in detail.

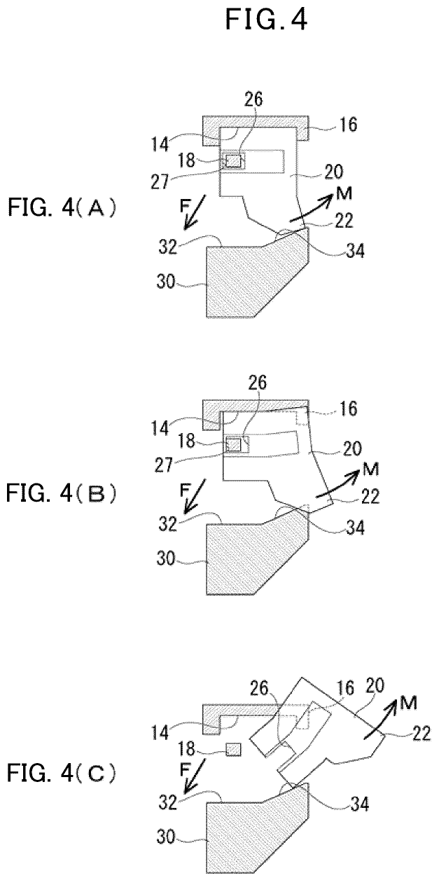

FIG. 2 is an example of a perspective view of a moving member 10 when viewed from below on the front side. A surface of the moving member 10 opposite to a surface facing the guide rail 5 (see FIG. 1) is defined as a front side of the moving member 10. As shown in FIG. 2, the cushioning member 20 has an abutting portion 22 in a substantially triangular shape at the tip thereof on the downward side. The cushioning member 20 has a cylindrical main body portion 24 above the abutting portion 22, the cylindrical main body portion 24 extending in a forward-backward direction. Although it is difficult to grasp from FIG. 2, the main body portion 24 has dimensions in the forward-backward direction longer than those of the abutting portion 22, and protrudes backward from the rear end of the abutting portion 22 (see FIG. 4 mentioned below). The main body portion 24 has an engaging groove 26 (see FIG. 4 mentioned below) that engages with a second come-off preventing claw 18 in the middle of the forward-backward direction.

The moving member 10 has a fitting portion 14 into which the cushioning member 20 is fitted at the end of the moving member 10 on the downward side. This fitting portion 14 opens downward. The main body portion 24 of the cushioning member 20 is inserted into this fitting portion 14 from the front side.

The moving member 10 comprises a first come-off preventing claw 16 and a second come-off preventing claw 18 that have a function to prevent the cushioning member 20 from coming off to the front side. The first come-off preventing claw 16 protrudes downward on the front side of the fitting portion 14 and restricts movement of the cushioning member 20 toward the front side, thereby suppressing the cushioning member 20 from coming off from the fitting portion 14, i.e., suppressing the cushioning member 20 from falling off. As mentioned above, the second come-off preventing claw 18 engages with the engaging groove 26 (see FIG. 4 mentioned below) of the cushioning member 20, thereby suppressing the cushioning member 20 from coming off from the fitting portion 14, i.e., suppressing the cushioning member 20 from falling off.

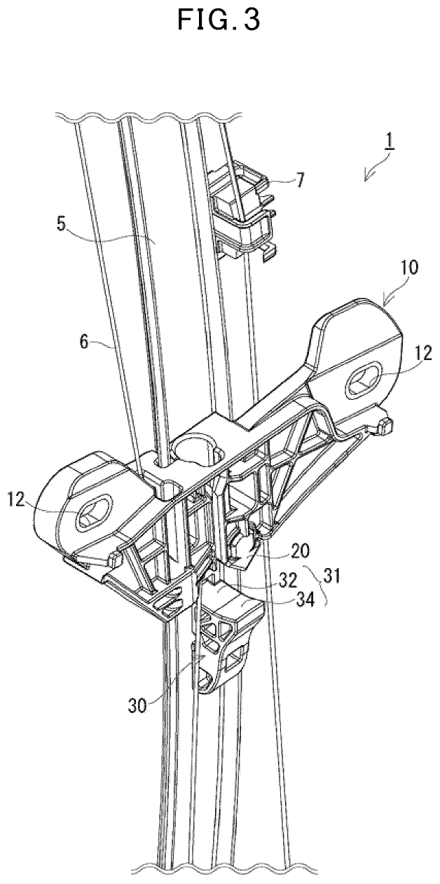

FIG. 3 is an example of a perspective view of a periphery of the moving member 10 when viewed from above on the front side. As shown in FIG. 3, the stopper 30 comprises a receiving portion 31 that abuts onto the cushioning member 20. This receiving portion 31 corresponds to the entire upper surface of the stopper 30. The receiving portion 31 has a base portion 32 on the guide rail 5 side and an inclined portion 34 on the front side with respect to the base portion 32. The base portion 32 is substantially perpendicular to the guide rail 5. The inclined portion 34 is inclined upward toward the forward direction at an angle of approximately 10° to 20° with respect to a plane perpendicular to the guide rail 5, i.e., the surface of the base portion 32. That is, the inclined portion 34 is inclined upward as it moves away from the guide rail 5 toward the forward direction.

In the object moving device 1 configured as mentioned above, when the motor 3 (see FIG. 1) rotates in one direction, the drum (not shown) rotates via the reducer, the inner cable 6 is driven in a circulating manner, and the moving member 10 is raised. When the moving member 10 is raised, for example, a window glass of a vehicle fixed to the fixing hole 12 of the moving member 10 is raised. On the other hand, when the motor 3 rotates in the other direction, the inner cable 6 is driven in a circulating manner in the reverse direction, and the moving member 10 is lowered. When the moving member 10 is lowered, for example, the window glass of the vehicle is lowered. Lowering of the moving member 10 is stopped when the cushioning member 20 abuts onto the stopper 30, for example, at the lower limit position.

### Problems That May Occur When Cushioning Member Abuts Onto Stopper

Next, problems that may occur when the moving member 10 moves downward and the cushioning member 20 abuts onto the stopper 30 will be described with reference to FIG. 4(A) to (C). FIG. 4(A) to (C) is an example of a schematic view showing side surfaces of the cushioning member 20 and the stopper 30 when viewed from the left side, in which (A) is a view showing a state when the cushioning member 20 abuts onto the stopper 30, (B) is a view showing a state when the cushioning member 20 comes off from the fitting portion 14, and (C) is a view showing a state after the cushioning member 20 comes off from the fitting portion 14.

When the moving member 10 (see FIGS. 1 to 3) moves downward, the cushioning member 20 abuts onto the stopper 30, as shown in FIG. 4(A). At this time, the abutting portion 22 of the cushioning member 20 abuts onto the inclined portion 34 of the stopper 30. Besides, a force F directed backward and downward acts on the moving member 10 with a cable pulling angle of the inner cable 6 (see FIG. 1 or 3). Therefore, a rotational moment M acts on the cushioning member 20 where the abutting portion 22 moves toward the front side (i.e., in a direction away from the guide rail 5). The direction in which this rotational moment M acts is a counterclockwise direction in FIG. 4.

When the cushioning member 20 repeatedly abuts onto the stopper 30, the above-mentioned rotational moment M repeatedly applies a load to the engaging groove 26 that engages with the second come-off preventing claw 18 and to the abutting portion 22. As such, as shown in FIG. 4(B), the first come-off preventing claw 16 bites into the main body portion 24 of the cushioning member 20, and the second come-off preventing claw 18 applies a force to a wall 27 at the rear end of the engaging groove 26. At this time, the abutting portion 22 of the cushioning member 20 attempts to climb over the inclined portion 34.

If the cushioning member 20 repeatedly abuts onto the stopper 30 after the cushioning member 20 and the stopper 30 become states shown in FIG. 4(B), there is a risk that the abutting portion 22 of the cushioning member 20 would greatly climb over the inclined portion 34 and the cushioning member 20 would fall off from the fitting portion 14, as shown in FIG. 4(C).

### Suppression of Cushioning Member From Falling Off

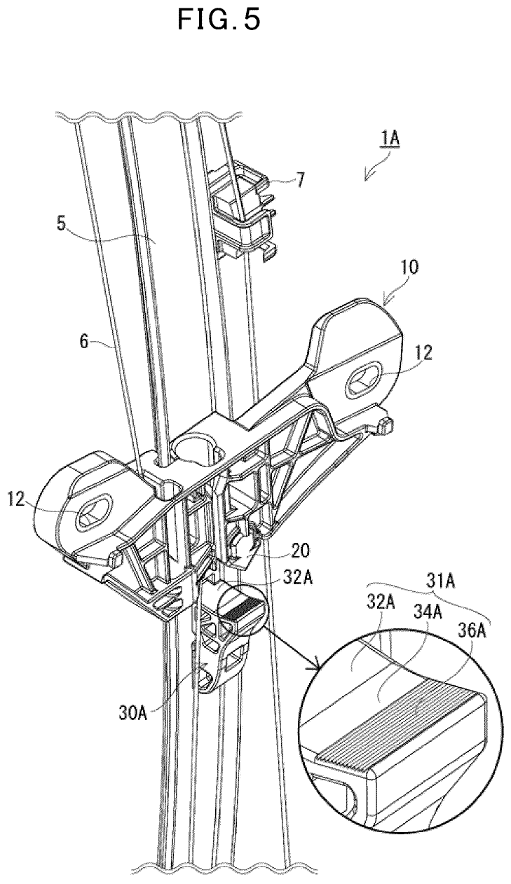

Next, an object moving device 1A according to the present embodiment will be described with reference to FIG. 5. FIG. 5 is an example of a perspective view of a periphery of a moving member 10 provided in the object moving device 1A according to the present embodiment, when viewed from above on the front side. It should be noted that, among various members provided in the object moving device 1A, the same members as various members, provided in the object moving device 1A as mentioned above, are denoted by the same reference numerals as in FIGS. 1 to 4.

The object moving device 1A according to the present embodiment, like a typical object moving device 1, mainly comprises a drive device 2 (see FIG. 1), a moving member 10, a guide rail 5, an inner cable 6, a cable guide 7, a direction changing member 8 (see FIG. 1), and a bracket 9 (see FIG. 1). The drive device 2, the moving member 10, the guide rail 5, the inner cable 6, the cable guide 7, the direction changing member 8, and the bracket 9 provided in the object moving device 1A are identical to the drive device 2, the moving member 10, the guide rail 5, the inner cable 6, the cable guide 7, the direction changing member 8, and the bracket 9 provided in the object moving device 1 as mentioned above, respectively, so that their explanations will be omitted.

Moreover, the object moving device 1A comprises a stopper 30A instead of the stopper 30 provided in the object moving device 1.

The stopper 30A, like the stopper 30, is a member that abuts onto the cushioning member 20 when the moving member 10 moves downward, and is provided on the guide rail 5 below the moving member 10. Moreover, the stopper 30A, like the stopper 30, is composed of, for example, POM that is excellent in abrasion resistance to be used as a material, but is not limited to this. For example, an elastic material may be used as a material, which can alleviate a shock when the cushioning member 20 abuts onto the stopper 30A.

The stopper 30A, like the stopper 30, has a base portion 32A that is substantially perpendicular to the guide rail 5 and an inclined portion 34A that is inclined toward the forward direction at an angle of approximately 10° to 20° with respect to the surface of the base portion 32A.

The stopper 30A, unlike the stopper 30, has a high frictional force portion 36A on the inclined portion 34A. In the present embodiment, the stopper 30A has the high frictional force portion 36A only on a part of the front side of the inclined portion 34A, but may have the high frictional force portion 36A over the entire inclined portion 34A.

The high frictional force portion 36A is a site where a frictional force between the high frictional force portion 36A and the cushioning member 20 is higher than that between a remaining portion of the receiving portion 31A and the cushioning member 20. In the present embodiment, the high frictional force portion 36A is, for example, a site where a groove shape is formed along a width direction perpendicular to an extending direction of the guide rail 5, i.e., a left-right direction. A convex portion having a groove shape extends continuously without interruption along the left-right direction. When the convex portion having a groove shape extends continuously along the left-right direction, it becomes possible to increase a grip force in the high frictional force portion 36A, i.e., a frictional force against the above-mentioned rotational moment M, compared to when the convex portion extends intermittently along the left-right direction. Moreover, the convex portion includes various forms of cross sections that can be seen when it is cut in a forward-backward direction, such as a square, a triangle with an apex angle, and an arc shape with no corner at an apex thereof. Furthermore, when the convex portions are formed, a groove portion is formed as the concave portion. In a case where an angle formed between the walls of this groove portion and the convex portion is 45 to 135 degrees (including the lower limit value and the upper limit value), preferably, in a case where an angle formed between the walls of the groove portion and the convex portion is 90 to 135 degrees (including the lower limit value and the upper limit value), or when a cross-sectional shape of the groove is an arc, in a case where an angle formed between a tangent line of the apex of the arc and the wall of the convex portion is 45 to 135 degrees (including the lower limit value and the upper limit value), preferably, in a case where an angle formed between the tangent line of the apex of the arc and the wall of the convex portion is 90 to 135 degrees (including the lower limit value and the upper limit value) when the cross-sectional shape of the groove is an arc, it becomes possible to further increase the frictional force between the high frictional force portion 36A and the cushioning member 20.

When the cushioning member 20 abuts onto the stopper 30A, the abutting portion 22 (see FIGS. 2 and 4) abuts onto the high frictional force portion 36A of the inclined portion 34A. Therefore, even if the above-mentioned rotational moment M (see FIG. 4) acts on the cushioning member 20, a relatively high frictional force caused by the high frictional force portion 36A can suppress the first come-off preventing claw 16 (see FIG. 4(B)) from biting into the main body portion 24 of the cushioning member 20. Moreover, it is also possible to reduce the force acting on the wall 27 at the rear end of the engaging groove 26 from the second come-off preventing claw 18 (see FIG. 4B for both). As a result, the abutting portion 22 of the cushioning member 20 can be suppressed from climbing over the inclined portion 34A, and even if the cushioning member 20 repeatedly abuts onto the stopper 30A, the cushioning member 20 can be suppressed from falling off from the fitting portion 14 (see FIGS. 3 and 4).

Moreover, the high frictional force portion 36A preferably has a plurality of convex portions provided along the left-right direction and parallel to each other. The greater the number of convex portion is, the further the frictional force that counteracts the above-mentioned rotational moment M can be increased.

### Variation

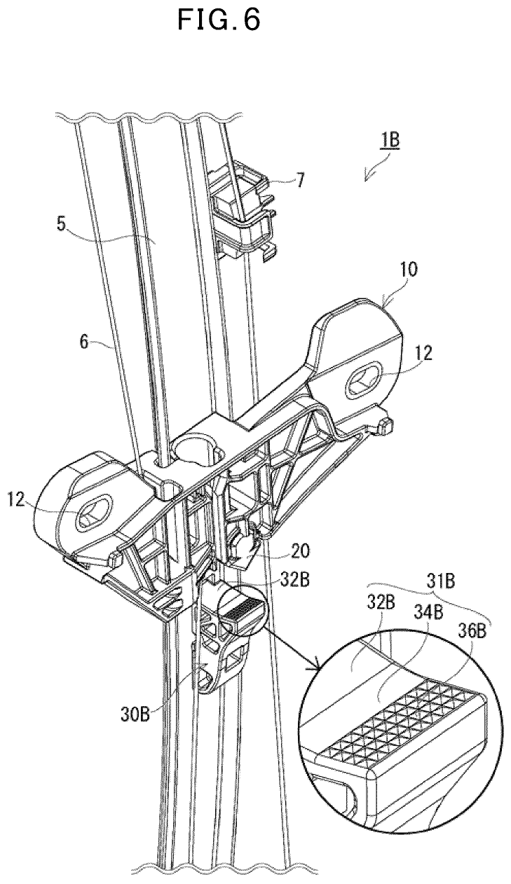

The above-mentioned embodiment has been described as an example of the present invention, but the present invention is not limited to the above-mentioned embodiment, and various modifications are possible within the scope of the claims. For example, the above-mentioned stopper 30A can be changed to a stopper 30B shown in FIG. 6.

FIG. 6 is an example of a perspective view of a periphery of a moving member 10 provided in an object moving device 1B according to a variation, when viewed from above on the front side. The object moving device 1B comprises a stopper 30B instead of the stopper 30A provided in the object moving device 1A. It should be noted that, except for the stopper 30B, various members provided in the object moving device 1B are identical to various members provided in the object moving device 1A. Therefore, the stopper 30B will be describe below, and descriptions of various members other than the stopper 30B will be omitted.

With respect to the stopper 30B, the shape of a convex portion in a high frictional force portion 36B is different from that of the stopper 30A, but other configurations of the stopper 30B are the same as those of the stopper 30A. Specifically, the stopper 30B is a member that abuts onto the cushioning member 20 when the moving member 10 moves downward, and is provided on the guide rail 5 below the moving member 10. Moreover, the stopper 30B, like the stopper 30A, is composed of, for example, POM that is excellent in abrasion resistance to be used as a material, but is not limited to this. It may be configured, like the stopper 30A, so that, for example, an elastic material is used as a material of the stopper 30B.

The stopper 30B, like the stopper 30A, has a base portion 32B that is substantially perpendicular to the guide rail 5 and an inclined portion 34B that is inclined toward the forward direction at an angle of approximately 10° to 20° with respect to the surface of the base portion 32B.

The stopper 30B comprises, on the inclined portion 34B, a high frictional force portion 36B having convex portions each having a corner at an apex thereof, for example, formed into a triangular pyramid or quadrangular pyramid shape. This high frictional force portion 36B, like the high frictional force portion 36A, is a site where a frictional force between the high frictional force portion 36B and the cushioning member 20 is higher than that between a remaining portion of the receiving portion 31B and the cushioning member 20. In this variation, the stopper 30B has the high frictional force portion 36B only on a part of the front side of the inclined portion 34B, but may have the high frictional force portion 36B over the entire inclined portion 34B. An apex angle of the convex portion in the triangular pyramid or quadrangular pyramid shape formed on the high frictional force portion 36B is preferably in a range of 10 to 90 degrees (including the lower limit value and the upper limit value).

In this way, even if the stopper 30A is changed to the stopper 30B, it is possible to increase a grip force in the high frictional force portion 36B, i.e., a frictional force against the above-mentioned rotational moment M, with a simple configuration. Accordingly, even if the cushioning member 20 repeatedly abuts onto the stopper 30B, the cushioning member 20 can be suppressed from falling off from the fitting portion 14 (see FIGS. 3 and 4).

In the above-mentioned embodiment and variation, the high frictional force portion 36A and the high frictional force portion 36B are convex portions formed on the inclined portion 34A and the inclined portion 34B, respectively. That is, the convex portions are obtained by molding materials themselves of the stopper 30A and the stopper 30B. However, the high frictional force portion 36A and the high frictional force portion 36B are not necessarily limited to those molded of the material themselves of the stopper 30A and the stopper 30B. For example, as long as they can resist the above-mentioned rotational moment M, materials that enhance the grip force may be attached to the inclined portion 34A and the inclined portion 34B.

Moreover, in the above-mentioned embodiment, the high frictional force portion 36A is formed into a groove shape, whereas, in the above-mentioned variation, the high frictional force portion 36B is formed into a triangular pyramid or quadrangular pyramid shape. However, a shape of a high frictional force portion is not limited to a convex, a groove, a triangular pyramid, and a quadrangular pyramid, and may be a cone, a hemisphere, or the like, as long as a frictional force between the high frictional force portion and the cushioning member 20 is higher than that between a remaining portion of the receiving portion (portion of the receiving portion except for the high frictional force portion) and the cushioning member 20. Within a range where the high frictional force portion can be provided, shapes such as a convex, a groove, a triangular pyramid, a quadrangular pyramid, a cone, a hemisphere, and the like may be arranged to be aligned in a linear shape, a wavy shape, or the like, or arranged randomly.

Moreover, in the above-mentioned embodiment, the object moving device 1A comprises, below the moving member 10, a stopper 30A that abuts onto the cushioning member 20 when the moving member 10 moves downward. Furthermore, in the above-mentioned variation, the object moving device 1B comprises, below the moving member 10, a stopper 30B that abuts onto the cushioning member 20 when the moving member 10 moves downward. However, it is not essential that the object moving device 1A comprises the stopper 30A below the moving member 10, and it is also not essential that the object moving device 1B comprises the stopper 30B below the moving member 10. For example, when the moving member 10 moves downward, the cushioning member 20 provided at the lower end of the moving member 10 may be configured to abut onto a member mounted to the guide rail 5. The member mounted to the guide rail 5 is, for example, a drive device 2 (a drum (not shown), a housing 4, etc.). As long as the cable guide 7 can be provided at the lower limit position of the moving member 10, the cable guide 7 is also included in the above-mentioned member mounted to the guide rail 5. In this way, when the cushioning member 20 is configured to abut onto the member mounted to the guide rail 5, it is preferable to provide a receiving portion having a high frictional force portion that corresponds to the above-mentioned high frictional force portion 36A or high frictional force portion 36B on the member onto which the cushioning member 20 abuts.

In the above-mentioned embodiment and variation, the moving member 10 has a fitting portion 14 into which the cushioning member 20 is fitted at the lower end. However, the fitting portion 14 is not necessarily limited to being provided at the lower end of the moving member 10. For example, in a case where the cushioning member 20 abuts onto a site above the lower end of the moving member 10 (e.g., the site on the right side of the fitting portion 14 shown in FIG. 2) when the moving member 10 moves downward, the fitting portion 14 may be provided at this site.

The embodiment and the variation have been described, but the present invention is not limited to the above-mentioned embodiment and variation, and various modifications are possible within the scope of the claims. It should be noted that the forms of the above-mentioned embodiment and variation mainly explain the inventions having the following configurations.
(1) An object moving device comprising:
a drive section;
a cable that is wound and unwound by the drive section;
a moving member to which a moving object is mounted, wherein the moving member is raised and lowered together with the moving object by winding and unwinding of the cable;
a guide rail extending in a moving direction of the moving object, wherein the guide rail slidably engages with the moving member and is capable of guiding a movement of the moving member;
a cushioning member provided on the moving member; and
a receiving portion that is provided on a member mounted to the guide rail and abuts onto the cushioning member to restrict the movement of the moving member;
wherein the receiving portion has a high frictional force portion provided at a site where the receiving portion abuts onto at least a part of the cushioning member, wherein a frictional force between the high frictional force portion and the cushioning member is higher than that between a remaining portion of the receiving portion and the cushioning member.
(2) The object moving device of (1), wherein the high frictional force portion comprises a convex portion formed at a site where the high frictional force portion abuts onto the cushioning member of the receiving portion.
(3) The object moving device of (2), wherein a plurality of convex portions is formed in a width direction that is a direction perpendicular to a direction in which the guide rail extends.
(4) The object moving device of (2) or (3), wherein the convex portion is formed to extend in the width direction of the guide rail.

### INDUSTRIAL APPLICABILITY

In the present embodiment and the variation, a window regulator that is installed on a door of a vehicle or the like and opens and closes a window glass of the vehicle is given as an example of an application for the object moving devices 1A, 1B to be employed, but they may be loaded into various devices, without limited to the window regulator.

### REFERENCE SIGNS LIST

1, 1A, 1B. Object moving device
2. Drive device
5. Guide rail
6. Inner cable
20. Cushioning member
31, 31A, 31B. Receiving portion
34, 34A, 34B. Inclined portion
36A, 36B. High frictional force portion

1.-4. (canceled)

5. An object moving device comprising:
a drive section;
a cable that is wound and unwound by the drive section;
a moving member to which a moving object is mounted, wherein the moving member is raised and lowered together with the moving object by winding and unwinding of the cable;
a guide rail extending in a moving direction of the moving object, wherein the guide rail slidably engages with the moving member and is capable of guiding a movement of the moving member;
a cushioning member provided on the moving member; and
a receiving portion that is provided on a member mounted to the guide rail and abuts onto the cushioning member to restrict the movement of the moving member;
wherein the receiving portion has a high frictional force portion provided at a site where the receiving portion abuts onto at least a part of the cushioning member, wherein a frictional force between the high frictional force portion and the cushioning member is higher than that between a remaining portion of the receiving portion and the cushioning member.

6. The object moving device of claim 5, wherein the high frictional force portion comprises a convex portion formed at a site where the high frictional force portion abuts onto the cushioning member of the receiving portion.

7. The object moving device of claim 6, wherein a plurality of convex portions is formed in a width direction that is a direction perpendicular to a direction in which the guide rail extends.

8. The object moving device of claim 6, wherein the convex portion is formed to extend in the width direction of the guide rail.
